(19) United States
(12) Patent Application Publication
(10) Pub. No.: US 2005/0132886 A1
(43) Pub. Date: Jun. 23, 2005

(54) Air filter for removing particulate matter and volatile organic compounds

(76) Inventors: Claudia Schultze, Greenville, DE (US); Joseph Norbert Weber, Newark, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(21) Appl. No.: 10/963,626

(22) Filed: Oct. 14, 2004

Related U.S. Application Data
(60) Provisional application No. 60/511,882, filed on Oct. 15, 2003.

(51) Int. Cl. B03C 3/00

(52) U.S. Cl. 96/66

(57) ABSTRACT

The present invention relates to an air filter for removing contaminants from air. Such a filter is useful in removing particulate matter, as well as volatile organic compounds (VOC's). In particular, the air filter of the present invention includes a reticulated foam substrate having a gel applied thereto. The substrate may be used alone or in combination with an electrostatic filter, which helps to trap smaller particles (i.e., less than 3 microns in diameter). The substrate itself may trap larger particles (i.e., greater than 3 microns in diameter).

### BACKGROUND OF THE INVENTION

1. Field of the Invention

The present invention relates to an air filter for removing contaminants from air, and in particular, to a reticulated foam substrate having a gel applied thereto. Such a filter is useful in removing particulate matter, as well as volatile organic compounds (VOC's).

2. Description of Related Art

The issue of indoor air quality is of increasing concern. The reduction of volatile organic compounds (VOC) emissions is a significant goal of environmental legislation such as the 1990 Clean Air Act. Traditionally, the principle medium for separating organic compounds from air or water has been activated carbon, but legislation has placed new demands on adsorbent media that are not being met by activated carbons available today when applied to the control of many VOC emissions. These needs include higher adsorbent capacity, resistance to high humidity, faster desorption kinetics and the ability to be easily and repeatedly regenerated on-site. Commercially available synthetic polymeric adsorbents offer the potential for meeting these needs.

Filters have traditionally been used for cleaning air. U.S. patent Publication No. 2003/0084788 to Fraser discloses a foam coated air filtration media. The air filter is made up of a substrate and a polymeric foam. The foam has a density gradient where the lower density upstream portion of the filter can trap larger particles, allowing smaller particles to penetrate into the filter and be trapped by the higher density downstream portion of the filter. However, there is no mention of VOC removal in this Publication.

A layered filter structure is disclosed in U.S. Pat. No. 5,419,953 to Chapman. The structure includes an electrostatically charged intermediate layer. A flame retardant prefilter layer of polyester removes large particles, and a backing of flame retardant liner polyester provides tear resistance. At least one of the layers is electrostatically charged to filter particles. Again, there is no discussion of VOC removal in this Patent.

In particular, the removal of VOC's has become of increasing importance, since the presence of these compounds has been linked to various health problems. The removal of aldehydes and acidic gases, which are VOC's, from air is discussed in U.S. Pat. Nos. 4,892,719 and 4,547,350 to Gesser. This removal is accomplished by coating a furnace filter in a forced air heating system. The coating is a polymeric amine, such as polyethylenimine with specific functional groups which react with the pollutants. VOC removal is also discussed in U.S. Pat. No. 5,529,609 to Gooch. This Patent discloses an air filter comprising a visco-elastic matrix of material for adsorbing airborne particular matter and for absorbing volatile liquids. The preferred three-dimensional visco-elastic matrix of material is a cross-linked water soluble polymer swelled with water or glycerol. A gel structure is formed between the cross-linked segments. However, the visco-elastic matrix structure can be difficult to work with.

Therefore, there exists a need in the art to remove both particulate matter and VOC's from the air. Preferably, such a structure would not rely on a visco-elastic matrix structure.

### BRIEF SUMMARY OF THE INVENTION

The present invention overcomes the problems associated with the prior art by providing a structure for supporting the gel. Specifically, a substrate having a tackified polymer gel applied thereto is used. The polymer gel contains sequestrant beads, which trap VOC's. A substrate made from reticulated foam has been found quite useful in holding sufficient amounts of the polymer gel for effective VOC removal. A reticulated foam also provides surface area for the gel to be applied to, and can be tailored in density to provide low pressure drop as well as a torturous path, hence maximizing the likelihood of VOCs coming in contact with the sequestrant. Moreover, because the surface of the substrate is tackified, it holds on to the particulate matter it traps and does not release it.

In addition, the air filter of the present invention may also include an electrostatic filter, or an electret, which can further trap fine particles before they reach the substrate. The electrostatic filter may also alter the path of the particles within the air stream passing through the filter so as to increase the probability that the particles will physically strike the tackified surface of the substrate and be trapped there. Thus, the electrostatic filter acts as a prefilter for very small particles. With the use of a substrate combined with an electrostatic filter, the air filter of the present invention is able to remove both fine particles, as well as VOC's.

Therefore, in accordance with the present invention, there is provided an air filter for removing contaminants from air. The air filter comprises a substrate having a gel applied thereto. The substrate comprises a reticulated foam. Preferably, the reticulated foam comprises either polyethylene or polyurethane.

Further in accordance with the present invention, there is provided an air filter for removing contaminants from air. The air filter comprises a substrate having a gel deposited thereon, and an electrostatic filter disposed in contact with one side of the substrate. Optionally, a post filter may be used on the other side of the substrate for providing structural integrity, as well as acting as a final fine particle filter.

### BRIEF DESCRIPTION OF THE DRAWINGS

FIG. 1 is a schematic diagram of the reticulated foam substrate of the present invention.

FIG. 2 is a schematic diagram of a substrate in combination with an electrostatic air filter and a post filter in accordance with the present invention.

FIG. 3 is a schematic diagram of an alternative embodiment of the present invention, where a sequestrant is provided on a perforated tape.

FIG. 4 is a schematic diagram of a modification of the embodiment of FIG. 3, where a sequestrant is provided on sheets of paper which form lamellae in a cylindrical configuration.

### DETAILED DESCRIPTION OF THE INVENTION

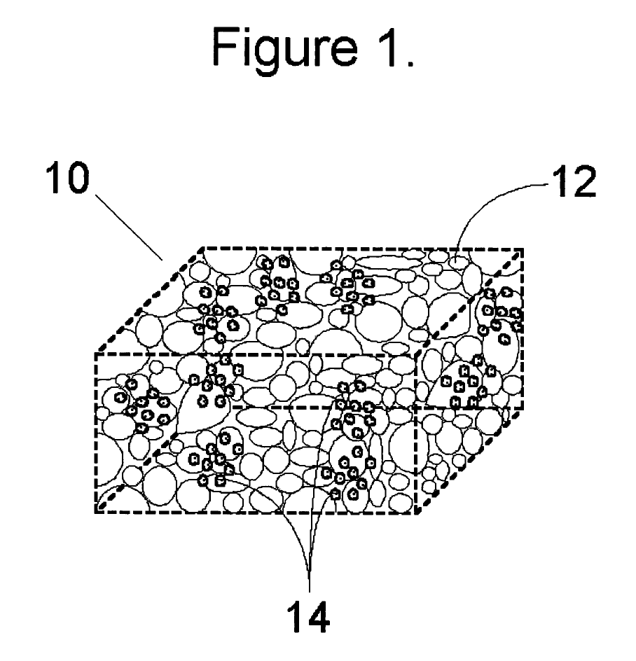

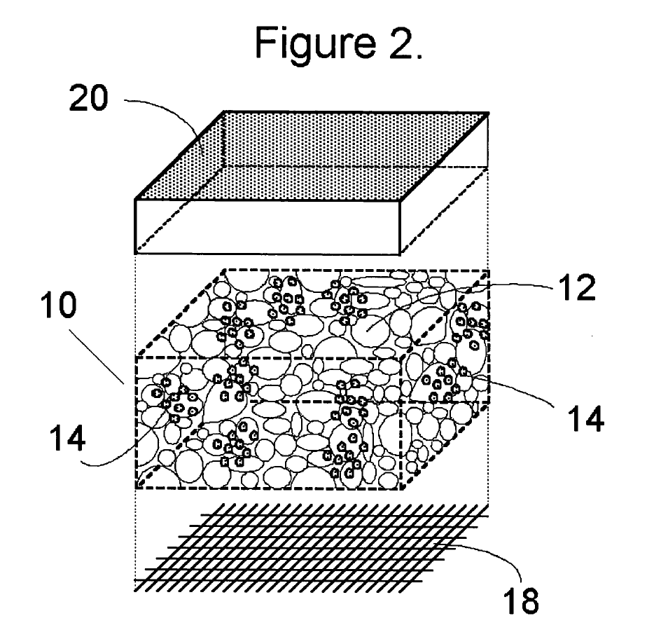

In accordance with the present invention, there is provided an air filter for removing contaminants from the air. A first embodiment of such a filter is shown generally at 10 in FIGS. 1 and 2.

Air filter as used herein refers to a system capable of separating airborne contaminants from the air. In the filtering process, the contaminated air is forced through a porous media, which traps the contaminants and prevents them from flowing through the media. In a first embodiment, the air filter comprises a substrate having a polymeric gel applied thereto. In this embodiment, airborne contaminants having a size of 0.3 microns or greater can be trapped by the gel. In a second embodiment, the air filter comprises a substrate in combination with an electrostatic filter. In this embodiment, airborne contaminants having a size of less than 0.3 microns can be trapped. In either the first or the second embodiment, the total thickness of the air filter of the present invention should not be greater than one inch. The substrate itself should have a thickness in the range of 0.25-0.5 inch.

The filter of the present invention comprises a substrate 12. The substrate is preferably a reticulated foam. By “reticulated” is meant that the foam is formed of open bubbles, rather than being a closed cell foam. A reticulated foam suitable for use with the present invention is a reticulated foam with 38 pores per inch, commercially available as S38 from Crest Foam Industries, Inc. The reticulated foam may be either polyester or polyurethane. Alternatively, the substrate can be a non-woven, which can be needle punched, spun laced, hydro-entangled, melt blown, spun bonded, thermal bonded, point bonded, resin bonded, airlaid and combinations of composites thereof, such as spun bonded melt blown spun bonded or spun bonded and needle punched. Exemplary non-woven substrates include needled felts made from polyester, polypropylene, viscose, rayon, polyethylene, and aramids; needled spun-bonded polyester; spunlace PET, Nomex® and Kevlar®; spunbonded non-wovens made from PET, nylon, polypropylene and polyethylene, thermally bonded nonwovens and resin bonded nonwovens. Those of ordinary skill in the art would recognize other substrates and fiber types that would be acceptable, depending on pricing and fitness for use in air filter applications, such as the ability to be coated with a polymer gel, reasonable cost, etc. The advantage of a reticulated foam as a substrate is its surface area and capacity to hold sufficient amount of the gel without loosing its structural integrity, which is not the case for non-woven substrates. In addition, the reticulated foam provides a relatively low pressure drop across the filter.

The gel may comprise a polyacrylamide polymer. Alternatively, the gel of the present invention may comprise an oil or an adhesive. If a polyacrylamide polymer is used, it could be either a copolymer or a homopolymer. In either case, the copolymer or the homopolymer is combined with sorbitol, deionized water and glycerol to form a solution. It is believed that sorbitol, deionized water and glycerol combine to plasticize the polyacrylamide polymer, or act as humectants or perform both functions. Sorbitol, mannitol, xylitol, sucrose, propylene glycol, or ethylene glycol and mixtures thereof are believe to act equivalently as humectants for the polymer and prevent its crystallization and therefore maintain a tacky state. In one embodiment, the gel comprises 90% polyacrylamide homopolymer and 10% copolymer. The copolymer in this case includes a monomer having anti-microbial activity. An example of such a copolymer is polyacrylamide co-diallydimethylammonium chloride, which is found in a polyacrylamide polymer, commercially available form Polyscience.

The gel of the present invention further comprises a sequestrant. The sequestrant is used to trap volatile organic compounds. The sequestrant is in the form of a bead. Such beads are shown at 14 in FIGS. 1 and 2. Typically, a solution of the gel and the sequestrant is made. The sequestrant is an ion exchange resin in the acid form or base form depending upon the type of VOC challenge to be removed by the filter. A mixture of acid and base forms of the ion exchange sequesterant is useful. A sequesterant suitable for use with the present invention is commercially available from Dow Chemicals, Inc., of Midland Mich., sold under the trademark DOWEX® OPTIPORE® V493 and V503 Adsorbents. Both DOWEX® OPTIPORE® products are described by Dow as methylene bridged copolymers of styrene and divinylbenzene. In addition, weakly basic ion exchange resins might be used as the sequestrant of the present invention to trap aldehydes, reversibly, since they contain primary and secondary amines which form “Schiff” bases/imines with the aldehydes. they contain primary and secondary amines which form “Schiff” bases/imines with the aldehydes.

The gel is applied to the substrate at a desired thickness while conforming to the shape of the substrate. When applied to the substrate, the gel can impregnate or intersperse throughout the foam without severe deterioration of the open bubbles that are characteristic of the reticulated foam. The gel can be applied to one or all faces of the substrate by a number of various techniques, including coating or dipping the substrate in the gel. A preferred technique is a “dip and squeeze method”, in which the substrate is dipped in the gel and the excess squeezed out. Exemplary coating techniques include coating with a knife blade or spatula. Alternatively, the gel may be sprayed on by an ultrasonic sprayer, such as that apparatus and method disclosed in Statutory Invention Registration number US H153-H1; to Staunton et al.

The substrate should have a permeability sufficient to allow an appreciable air flow through the media. In one embodiment, the filter has an air permeability of about 1030 cubic ft/min, as measured by the Frazier air permeability method. The substrate has an initial resistance in the range of 0.5-0.6, as measured in inches of water (gauge).

A surfactant may be applied to the substrate to adhere the gel to the substrate. The surfactant is preferably a non-ionic, or amphotermic surfactant. An example of a surfactant suitable for use with the present invention is a non-ionic surfactant, sold under the trademark Zonyl® FSH, by E.I. du Pont de Nemours and Company of Wilmington, Del.

Further in accordance with a second embodiment of the present invention, the air filter may also include an electrostatic air filter. Such an air filter is shown at 20 in FIG. 2, and is disposed in contact with one side of the substrate. The electrostatic filter of the present invention is preferably an electret, meaning a dielectric body in which a permanent statet of electric polarization has been set up. The purpose of the electrostatic air filter is to increase the trapping efficiency of fine particles The electrostatic filter may comprise a non-woven fiber which comprises a plurality of charged fibers. An example of an electrostatic filter suitable for use with the present invention is sold under the trademark Filtrete® by 3M.

In this embodiment, the air filter of the present invention may also include an insulating layer (not shown) which is disposed between the electrostatic filter and the substrate. Since water will short circuit the electrostatic function of the electrostatic filter, the insulating layer is provided to separate the electrostatic filter from direct contact with the gel on the substrate, which is aqueous.

Optionally, the air filter of the present invention may also include a post filter, shown at 18 in FIG. 2. The post filter is disposed on the side of the substrate opposite the electrostatic filter. The purpose of the post filter is to add structural integrity to the filter. In addition, the post-filter shields the substrate so as to avoid premature exposure during processing, packaging, handling etc. Also, the post filter may act as a final fine particle filter, depending on the construction chosen.

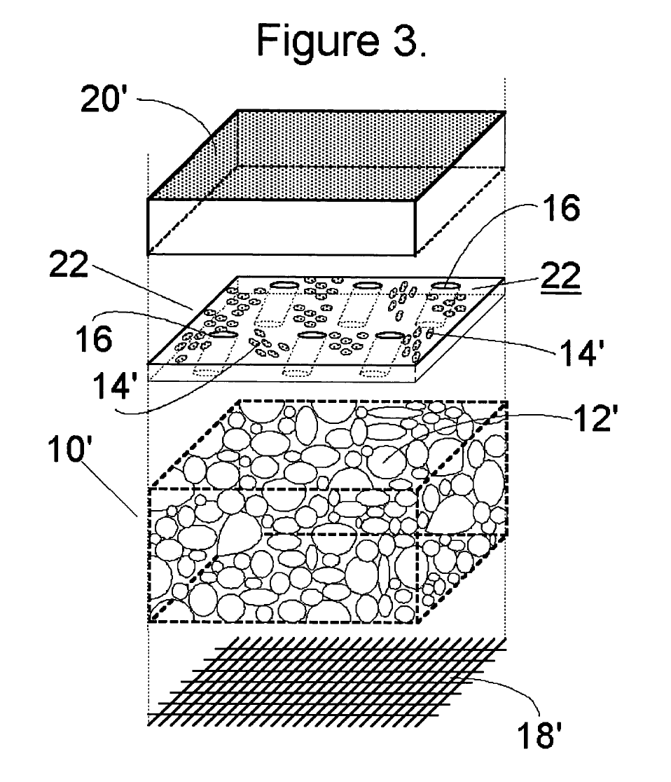

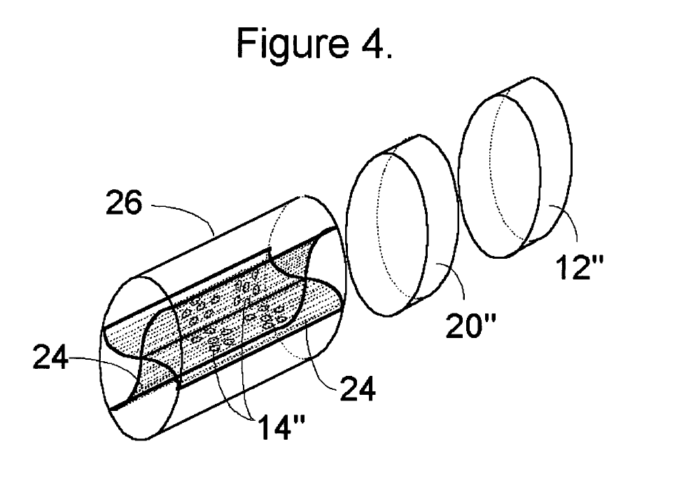

In accordance with a third embodiment of the present invention, there is provided an air filter for removing contaminants from air. This embodiment is shown in FIGS. 3 and 4, where the air filter is shown generally at 10′and 10″, respectively. This embodiment shown in FIG. 3 is referred to as the “no gel” embodiment in that no gel as described above is used. Instead, the air filter comprises a tackified, perforated medium 22 in FIG. 3. This medium 22 could be a double-sided tape, or a fly paper, or any medium that has a tacky substance, such as an adhesive, applied thereto on an upper surface 22 of medium 22 shown in FIG. 3. Suitable adhesives include: polyurethane based, cyanoacrylate based, and polyamide or polyester based resins. A suitable cyanoacrylate based tackifier called Super Bonder® Instant Adhesive may be obtained HENKEL LOCTITE CORPORATION, Rocky Hill, Conn., USA, 06067-3910. Such an adhesive medium is about 0.3 mils thick. The perforated medium 22 in FIG. 3 is about 0.5 to 10 millimeters thick and serves to support the sequesterant on the substrate 12′. Perforations, shown at 16, are made in the tackifier and pass through the medium 22; such that air flow impinging on surface 22 is able to pass through medium 22.

A sequestrant is disposed on one side of the tackified medium. The sequestrant is illustrated in FIGS. 3 and 4 at 14′ and 14″, respectively. The sequestrant is the same type of sequestrant as described above with respect to the first two embodiments. The air filter of this embodiment may further comprise a substrate, as shown at 12′ in FIG. 3. The substrate, 12″ in FIG. 4, is the same type of substrate as described above with respect to the first two embodiments; however, having cylindrical geometry here. In addition, an electrostatic filter, such as the filter used in the second embodiment as described above, may be used on the side of the tackified medium where the beads of sequestrant are disposed. Such an air filter is shown at 20′ in FIG. 3.

In the cylindrical geometry embodiment shown in FIG. 4, the tackified medium comprises a plurality of sheets of paper, cardboard, plastic, thin metallic sheets, or the like. The sheets of paper, for example, are arranged in pinwheel fashion in a cylindrical configuration, so as to form lamellae, inside a cardboard, plastic or metallic cylinder 26 shown in FIG. 4. A representation of two such lamellae are shown at 24 in FIG. 4. The sequestrant beads 14″ are disposed on both sides of such paper 24. The optional electrostatic filter 20″ and the filter substrate 12″ are shown having a cylindrical geometry in order to mate optimally with the geometry of the lamellar sheet supported embodiment of FIG. 4. Optionally, the cardboard, plastic or metallic cylinder 26 may extend sufficiently so as to contain and support elements 20″ and 12″, as well as, the lamellae 24.

The advantage of the “no gel” embodiments of FIGS. 3 and 4 is that there is no need to apply a gel, which is wet and heavy, to the paper, to integrity of the filter. Moreover, without the aqueous gel there is less chance that the electrostatic function of the electrostatic filter will be short circuited, should one be used. In addition, the configuration of FIG. 4 is particularly advantageous in that the pressure drop across this filter is low. It is believed that radial arrangements of the lamellae, 24 in FIG. 4, provides an air flow path, through the tube 26, of less tortuosity thus lessing the possibility for filter clogging by air entrained particles entrain the sequestrant. The weight of the gel could lessen the structural integrity.

### EXAMPLES

### Example 1

Filter test specimens were prepared in the following manner. First, a tacky polymer gel was synthesized by combining the following components in weight ratios of 1.17 g polyacrylamide (Polyscience); 1.30 g polyacrylamide-co-diallyldimethylammonium chloride; 5.20 g sorbitol; 10.53 g deionized Water; 6.50 g glycerol and then diluting the resulting composition to 1:2 using an additional 26.00 g deionized water. The solution resulting was covered and slowly stirred overnight at ambient temperature (for about 12 hours). Next, 2.5 grams of a sequesterant, was added and allowed to become homogeneously suspended by mechanical stirring. Sequesterants preferred here were DOWEX® OPTIPORE® V493 and V503 (polymeric adsorbents available from Dow Chemicals, Inc.; the properties of V493 include: particle size range 20-50 Mesh, BET specific (square meter/gram) surface 1100, porosity 1.16 cubic cm per gram, average pore diameter 46 angstrom, and density 0.34 gram/cubic cm; the properties of V503 include: particle size range 1.5 mm, BET specific (square meter/gram) surface 1080, porosity 0.94 cubic cm per gram, average pore diameter 34 angstrom, and density 0.4 gram/cubic cm). Afterwards, but immediately before application to the substrate, 20 drops of a nonionic surfactant, ZONYL® FSH from E. I. du Pont de Nemours and Company, was added and stirred briefly prior to application. This composition was applied directly to a substrate comprised of a 12 inch by 12 inch reticulated foam with 38 pores per inch (known as S38 from CREST FOAM INDUSTRIES Inc., British Vita Cellular Polymers Group. The direct application of the tacky polymer gel was made with a 12 inch “drywall compound” blade to one 12 inch by 12 inch face of the substrate evenly. The amount of tacky polymer gel applied was determined by weighing and was 208 grams. The coated substrate with tacky polymer gel was placed in an oven at 140° C. and heated for 30 minutes. The coated substrate was then cooled and equilibrated with ambient moisture at room temperature for 3 days. Next, a pre-filter fabric comprised of a 1×1 woven with nylon in the warp direction and polypropylene in the weft (obtained from Wendell Fabrics Corp. at 108 E. Church St. Blacksburg, South Carolina 29702; woven STLO1; pattern QL 5620-21) was laid down over the substrate side treated with tacky polymer gel, completely covering the 12 inch by 12 inch face. A post-filter fabric of the same construction was applied to the opposing face of the 12 inch by 12 inch substrate.

The resulting sandwich structure, comprised of the pre-filter fabric, the treated substrate and the post-filter fabric, was affixed to and retained in a frame which could be mounted into a cross-sectional space of an air handling duct for testing purposes. The testing procedures included the initial efficiency in removal of ambient atmospheric dust particles according to ASHRAE METHOD 52.1-1992; airflow versus resistance and initial ambient particle size removal, reported in Table 1a. and tobacco smoke particulate matter removal reported in Table 1b.

The test conditions were: air flow rate=110 cubic feet per minute at 23° C. and 50% relative humidity. The initial flow resistance of the Example 1 filter was 1.08 inches of water (gauge).

TABLE 1a

| Ambient Atmospheric Particles Size | Example 1. Removal Efficiency |
|---|---|
| Range (micrometers) | (percent) |
| 0.7-1.0 | 11.47 |
| 1.0-1.3 | 38.00 |
| 1.3-1.6 | 51.43 |
| 1.6-2.2 | 61.37 |
| 2.2-3.0 | 70.90 |
| 3.0-4.0 | 74.91 |
| 4.0-5.5 | 83.20 |
| 5.5-7.0 | 88.52 |
| 7.0-10.0 | 85.00 |

TABLE 1b

| Tobacco Smoke Particles Size | Example 1. Removal Efficiency |
|---|---|
| Range (micrometers) | (percent) |
| 0.7-1.0 | 0.0 |
| 1.0-1.3 | 30.61 |
| 1.3-1.6 | 56.77 |
| 1.6-2.2 | 73.59 |
| 2.2-3.0 | 87.86 |
| 3.0-4.0 | 85.18 |
| 4.0-5.5 | 89.42 |
| 5.5-7.0 | 90.30 |
| 7.0-10.0 | 91.67 |

### Example 2

A second filter test specimen was prepared in precisely the same manner as in Example 1, with one difference. The amount nonionic surfactant, ZONYL® FSH, was varied from Example 1. In this case, 10 drops were added to the tacky polymer gel composition and stirred briefly prior to application. The same sandwich structure of coated substrate was assembled for testing purposes.

The test conditions were: air flow rate=110 cubic feet per minute at 23° C. and 50% relative humidity. The initial flow resistance of the Example 2 filter was 0.13 inches of water (gauge).

TABLE 2a

| Ambient Atmospheric Particles Size | Example 2. Removal Efficiency |
|---|---|
| Range (micrometers) | (percent) |
| 0.7-1.0 | 0.0 |
| 1.0-1.3 | 9.66 |
| 1.3-1.6 | 9.92 |
| 1.6-2.2 | 28.62 |
| 2.2-3.0 | 48.20 |
| 3.0-4.0 | 61.59 |
| 4.0-5.5 | 64.06 |
| 5.5-7.0 | 85.94 |
| 7.0-10.0 | 70.59 |

TABLE 2b

| Tobacco Smoke Particles Size | Example 2. Removal Efficiency |
|---|---|
| Range (micrometers) | (percent) |
| 0.7-1.0 | 0.0 |
| 1.0-1.3 | 0.0 |
| 1.3-1.6 | 14.34 |
| 1.6-2.2 | 39.12 |
| 2.2-3.0 | 79.43 |
| 3.0-4.0 | 77.32 |
| 4.0-5.5 | 92.51 |
| 5.5-7.0 | 97.80 |
| 7.0-10.0 | 99.31 |

### Example 3

A third filter test specimen was prepared in precisely the same manner as in Example 1, with one difference. The amount nonionic surfactant, ZONYL® FSH, was varied from Example 1. In this case, 5 drops were added to the tacky polymer gel composition and stirred briefly prior to application. The same sandwich structure of coated substrate was assembled for testing purposes.

The test conditions were: air flow rate=110 cubic feet per minute at 23° C. and 50% relative humidity. The initial flow resistance of the Example 3 filter was 0.045 inches of water (gauge).

TABLE 3a

| Ambient Atmospheric Particles Size | Example 3. Removal Efficiency |
|---|---|
| Range (micrometers) | (percent) |
| 0.7-1.0 | 0.0 |
| 1.0-1.3 | 10.51 |
| 1.3-1.6 | 14.64 |
| 1.6-2.2 | 15.21 |
| 2.2-3.0 | 24.22 |
| 3.0-4.0 | 37.78 |
| 4.0-5.5 | 54.38 |
| 5.5-7.0 | 69.95 |
| 7.0-10.0 | 51.28 |

TABLE 3b

| Tobacco Smoke Particles Size | Example 3. Removal Efficiency |
|---|---|
| Range (micrometers) | (percent) |
| 0.7-1.0 | 0.0 |
| 1.0-1.3 | 0.0 |
| 1.3-1.6 | 10.08 |
| 1.6-2.2 | 16.73 |
| 2.2-3.0 | 45.48 |
| 3.0-4.0 | 39.78 |
| 4.0-5.5 | 59.03 |
| 5.5-7.0 | 63.93 |
| 7.0-10.0 | 41.03 |

### Example 4

A fourth filter test specimen was prepared in precisely the same manner as in Example 1, with one difference. No nonionic surfactant, ZONYL® FSH, was added to the tacky polymer gel composition. The same sandwich structure of coated substrate was assembled for testing purposes.

The test conditions were: air flow rate=110 cubic feet per minute at 23° C. and 50% relative humidity. The initial flow resistance of the Example 2 filter was 0.08 inches of water (gauge).

TABLE 4a

| Ambient Atmospheric Particles Size | Example 4. Removal Efficiency |
|---|---|
| Range (micrometers) | (percent) |
| 0.7-1.0 | 0.0 |
| 1.0-1.3 | 2.44 |
| 1.3-1.6 | 7.88 |
| 1.6-2.2 | 12.76 |
| 2.2-3.0 | 29.08 |
| 3.0-4.0 | 41.46 |
| 4.0-5.5 | 61.92 |
| 5.5-7.0 | 78.79 |
| 7.0-10.0 | 88.89 |

TABLE 4b

| Tobacco Smoke Particles Size | Example 4. Removal Efficiency |
|---|---|
| Range (micrometers) | (percent) |
| 0.7-1.0 | 0.0 |
| 1.0-1.3 | 0.0 |
| 1.3-1.6 | 0.0 |
| 1.6-2.2 | 0.0 |
| 2.2-3.0 | 0.0 |
| 3.0-4.0 | 0.0 |
| 4.0-5.5 | 0.0 |
| 5.5-7.0 | 34.54 |
| 7.0-10.0 | 60.00 |

### Example 5

Additional filter test specimens were prepared in precisely the same manner as in Example 1. The same sandwich structure of coated substrate was assembled for testing purposes using VOC model compounds, methyl pyridine and acetic acid, in order to study the effectiveness of VOC removal from air. Each VOC model compound was presented at a challenge concentration in the range of 80 to 85 parts per million (PPM). The test conditions included the presenting the VOC model compound challenge concentration in air at a flow rate in the range of 90 to 100 cubic feet per minute at 25° C. and 50% relative humidity. The filter diameter was 11.4 cm, the air face velocity was 0.17 meters per second. In the case of methyl pyridine, the gel also contained an ion exchange resin (DOWEX® OPTIPORE®) sequesterant in the acid form. The ion exchange resin containing gel was compared versus the polyurethane foam and gel alone. In the case of acetic acid, the gel containing an ion exchange resin sequesterant in the base form was compared versus the polyurethane foam and gel alone. The filter breakthrough concentration (PPM) after 30 second, 60 seconds and 10 minutes exposure to the VOC model compound are shown in the following table (Table 5.).

Clearly shown by these data in Table 5 is a benefit from providing an ion exchange resin sequesterant. The ion exchange resin as a component of the gel where acidic or basic VOC are to be captured is a useful form for the filter according to the invention.

TABLE 5

| VOC model | Ion | | | |
|---|---|---|---|---|
| compound | Ex- | Breakthrough | Breakthrough | Breakthrough |
| (pre- | change | Concentration | Concentration | Concentration |
| sented @ | Resin | PPM (after 30 | PPM (after 60 | PPM (after 10 |
| 80 PPM) | Present | seconds) | seconds) | minutes) |
| methyl | Acid | 18 | 43 | 69 |
| pyridine | Form | | | |
| methyl | none | 43 | 69 | 75 |
| pyridine | | | | |
| acetic acid | Base | 26 | 45 | 71 |
| | Form | | | |
| acetic acid | none | 35 | 56 | 80 |

### CONTROL EXAMPLE

A control example was prepared using the same 12 inch by 12 inch substrate of reticulated foam with 38 pores per inch (known as S38 from CREST FOAM INDUSTRIES Inc.). The substrate was untreated with tacky polymer. This untreated substrate was fashioned into a sandwich structure along with the pre-filter fabric and the post-filter fabric as before. This sandwich was affixed to and retained in a frame which could be mounted into a cross-sectional space of an air handling duct for testing purposes identical to those of the examples.

The test conditions were: air flow rate=110 cubic feet per minute at 23° C. and 50% relative humidity. The initial flow resistance of the Example 2 filter was 0.03 inches of water (gauge).

TABLE 5a

| Ambient Atmospheric Particles | Control Example Removal |
|---|---|
| Size Range (micrometers) | Efficiency (percent) |
| 0.7-1.0 | 6.52 |
| 1.0-1.3 | 13.10 |
| 1.3-1.6 | 13.18 |
| 1.6-2.2 | 13.95 |
| 2.2-3.0 | 21.17 |
| 3.0-4.0 | 30.54 |
| 4.0-5.5 | 50.68 |
| 5.5-7.0 | 60.13 |
| 7.0-10.0 | 72.73 |

TABLE 5b

| Tobacco Smoke Particles Size | Control Example Removal Efficiency |
|---|---|
| Range (micrometers) | (percent) |
| 0.7-1.0 | 0.0 |
| 1.0-1.3 | 0.0 |
| 1.3-1.6 | 0.0 |
| 1.6-2.2 | 0.0 |
| 2.2-3.0 | 12.32 |
| 3.0-4.0 | 14.89 |
| 4.0-5.5 | 23.30 |
| 5.5-7.0 | 22.43 |
| 7.0-10.0 | 34.69 |

### Electret Control Example 1

An electret control example was prepared using a FILTRETE™ electrostatic filter medium from 3M Corporation. This FILTRETE™ brand of electrostatic filter medium uses an electret type of media and synthetic fiber substrate to remove particles from the air. This filter was tested exactly as in the prior examples.

The test conditions were: air flow rate=120 cubic feet per minute at 23° C. and 50% relative humidity. The initial flow resistance of the Example 2 filter was 0.04 inches of water (gauge).

TABLE 6a

| | Electret Control |
|---|---|
| Ambient Atmospheric Particles Size | Example 1. Removal |
| Range (micrometers) | Efficiency (percent) |
| 0.7-1.0 | 70.81 |
| 1.0-1.3 | 77.89 |
| 1.3-1.6 | 82.77 |
| 1.6-2.2 | 87.20 |
| 2.2-3.0 | 94.62 |
| 3.0-4.0 | 96.53 |
| 4.0-5.5 | 98.75 |
| 5.5-7.0 | 93.37 |
| 7.0-10.0 | 100.0 |

TABLE 6b

| Tobacco Smoke Particles Size | Electret Control Example 1. |
|---|---|
| Range (micrometers) | Removal Efficiency (percent) |
| 0.7-1.0 | 74.01 |
| 1.0-1.3 | 83.97 |
| 1.3-1.6 | 90.78 |
| 1.6-2.2 | 89.74 |
| 2.2-3.0 | 93.49 |
| 3.0-4.0 | 92.70 |
| 4.0-5.5 | 95.92 |
| 5.5-7.0 | 98.94 |
| 7.0-10.0 | 96.35 |

### Electret Control Example 2

An electret control example was prepared using a FILTRETE™ electrostatic filter medium from 3M Corporation. This FILTRETE® brand of electrostatic filter medium uses an electret type of media and glass fiber substrate to remove particles from the air. This filter was tested exactly as in the prior examples.

The test conditions were: air flow rate=120 cubic feet per minute at 23° C. and 50% relative humidity. The initial flow resistance of the Example 2 filter was 0.04 inches of water (gauge).

TABLE 7a

| Ambient Atmospheric Particles Size | Electret Control Example 2. |
|---|---|
| Range (micrometers) | Removal Efficiency (percent) |
| 0.7-1.0 | 49.27 |
| 1.0-1.3 | 59.20 |
| 1.3-1.6 | 65.65 |
| 1.6-2.2 | 76.07 |
| 2.2-3.0 | 87.31 |
| 3.0-4.0 | 90.99 |
| 4.0-5.5 | 97.08 |
| 5.5-7.0 | 97.18 |
| 7.0-10.0 | 95.24 |

TABLE 7b

| Tobacco Smoke Particles Size | Electret Control Example 2. |
|---|---|
| Range (micrometers) | Removal Efficiency (percent) |
| 0.7-1.0 | 20.59 |
| 1.0-1.3 | 64.89 |
| 1.3-1.6 | 80.85 |
| 1.6-2.2 | 86.58 |
| 2.2-3.0 | 92.57 |
| 3.0-4.0 | 91.69 |
| 4.0-5.5 | 96.35 |
| 5.5-7.0 | 98.00 |
| 7.0-10.0 | 99.02 |

These examples show that addition of the electret filter would provide an added benefit in particulate removal used in a serially arranged fashion with the filter specimens of Examples 1 through 4. Efficient particulate removal prior to a filter assembly optimized for VOC removal is a further aspect of our invention. Other aspects of the invention my be readily apparent to those skilled in the art having the benefit of the foregoing teachings. Such further modifications or substitutions may be made without departing from the spirit and scope of the invention.

1. An air filter for removing contaminants from air, comprising a substrate having a gel applied thereto, wherein the substrate comprises a reticulated foam.

2. An air filter for removing contaminants from air, comprising:
(a) an electrostatic filter; and
(b) a substrate having one side disposed in contact with the electrostatic filter, wherein the substrate has a gel applied thereto.

3. The air filter of claim 1, wherein the reticulated foam is either polyester or polyurethane.

4. The air filter of claims 1 or 2, wherein the gel comprises a polyacrylamide polymer.

5. The air filter of claim 4, wherein the polyacrylamide is a homopolymer, and the gel comprises 90% of the polyacrylamide homopolymer and 10% copolymer.

6. The air filter of claim 5, wherein the copolymer comprises a monomer having anti-microbial activity.

7. The air filter of claims 1 or 2, wherein the gel further comprises sequestrant.

8. The air filter of claim 7, wherein the sequestrant is an ion-exchange resin in the acid form.

9. The air filter of claim 1, further comprising an electrostatic filter disposed in contact with one side of the substrate.

10. The air filter of claims 1 or 2, further comprising a post-filter disposed in contact with the side of the substrate opposite the electrostatic filter.

11. The air filter of claims 1 or 2, wherein the substrate further includes a surfactant for adhering the gel to the substrate.

12. A method of removing contaminants from air, comprising filtering air through an air filter including a substrate comprising a reticulated foam having a gel applied thereto.

13. A method of removing contaminants from air, comprising filtering air through an air filter including a substrate and an electrostatic filter disposed in contact with one side of the substrate, such that air flow is directed serially to the electrostatic filter first and then through the substrate.

14. The method of claims 12 or 13, wherein the filtering step comprises removing volatile organic compounds from the air.

15. The method of claim 11, wherein the filtering step comprises removing particulates from the air.

16. An air filter for removing contaminants from the air, comprising:
(a) a tackified, perforated medium; and
(b) a sequestrant disposed on the tackified medium.

17. The air filter of claim 16, wherein the tackified medium comprises a tape.

18. The air filter of claim 16, wherein the sequestrant comprises a plurality of beads disposed on one side of the tackified medium.

19. The air filter of claim 18, wherein the beads comprise an ion exchange medium.

20. The air filter of claim 18, further including a substrate disposed on the other side of the tackified medium.

21. The air filter of claim 16, wherein the tackified medium comprises a plurality of sheets of paper, disposed about a cylinderin pin-wheel like manner to form lamellae.

22. The air filter of claim 16, wherein the sequestrant is disposed on both sides of the paper.
